(19) United States
(12) Patent Application Publication
(10) Pub. No.: US 2014/0071894 A1
(43) Pub. Date: Mar. 13, 2014

(54) VARIABLE BLOCK LENGTH AND SUPERPOSITION CODING FOR HYBRID AUTOMATIC REPEAT REQUEST

(71) Applicant: QUALCOMM Incorporated, San Diego, CA (US)

(72) Inventors: Peter KAIROUZ, San Diego, CA (US); Ahmed Kamel SADEK, San Diego, CA (US); Tamer Adel KADOUS, San Diego, CA (US)

(73) Assignee: QUALCOMM Incorporated, San Diego, CA (US)

(21) Appl. No.: 14/025,713

(22) Filed: Sep. 12, 2013

Related U.S. Application Data
(60) Provisional application No. 61/700,845, filed on Sep. 13, 2012.
(60) Provisional application No. 61/700,814, filed on Sep. 13, 2012.

(51) Int. Cl. H04W 88/06

(52) U.S. Cl. CPC H04W 88/06
USPC 370/328

(57) ABSTRACT

An eNB may retransmit packets according to a hybrid automatic repeat request using superposition coding. In one instance, the eNB receives a negative-acknowledgement of an initially transmitted packet and retransmits at least one packet according to hybrid automatic repeat request using superposition coding in response to the negative-acknowledgement. The eNB also retransmits packets according to variable block length retransmission. In this instance, the eNB receives a negative-acknowledgement of an initially transmitted fixed block length packet and retransmits a variable block length packet in response to the negative-acknowledgement

### REFERENCE TO RELATED APPLICATIONS

The present application claims priority to U.S. Provisional Patent Application No. 61/700,845 filed Sep. 13, 2012 entitled “SUPERPOSITION CODING FOR HYBRID AUTOMATIC REPEAT REQUEST (HARM) TRANSMISSION,” in the names of KAIROUZ, et al., and also claims priority to U.S. Provisional Patent Application No. 61/700,814 filed Sep. 13, 2012 entitled “VARIABLE BLOCK LENGTH FOR HYBRID AUTOMATIC REPEAT REQUEST,” in the names of KAIROUZ, et al., the disclosures of which are expressly incorporated herein by reference in their entireties.

The present application relates to U.S. Provisional Patent Application No. 61/603,181 filed Feb. 24, 2012 entitled “MITIGATING CROSS-DEVICE INTERFERENCE,” in the names of SADEK, et al., and U.S. Provisional Patent Application No. 61/602,816 filed Feb. 24, 2012 entitled “MULTI-RADIO COEXISTENCE,” in the names of KADOUS, et al, the disclosures of which are expressly incorporated herein by reference in their entireties. The present application relates to U.S. patent application Ser. No. 13/762,107 filed Feb. 7, 2013 entitled “MITIGATING CROSS-DEVICE INTERFERENCE,” in the names of SADEK, et al., the disclosures of which are expressly incorporated herein by reference in their entireties.

### TECHNICAL FIELD

The present description is related, generally, to multi-radio techniques and, more specifically, to variable block length coding for hybrid automatic repeat request and to retransmitting according to hybrid automatic repeat request using superposition coding.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-single-out or a multiple-in-multiple out (MIMO) system.

Some conventional advanced devices include multiple radios for transmitting/receiving using different Radio Access Technologies (RATs). Examples of RATs include, e.g., Universal Mobile Telecommunications System (UMTS), Global System for Mobile Communications (GSM), cdma2000, WiMAX, WLAN (e.g., WiFi), Bluetooth, LTE, and the like.

An example mobile device includes an LTE User Equipment (UE), such as a fourth generation (4G) mobile phone. Such 4G phone may include various radios to provide a variety of functions for the user. For purposes of this example, the 4G phone includes an LTE radio for voice and data, an IEEE 802.11 (WiFi) radio, a Global Positioning System (GPS) radio, and a Bluetooth radio, where two of the above or all four may operate simultaneously. While the different radios provide useful functionalities for the phone, their inclusion in a single device gives rise to coexistence issues. Specifically, operation of one radio may in some cases interfere with operation of another radio through radiative, conductive, resource collision, and/or other interference mechanisms. Coexistence issues include such interference.

This is especially true for the LTE uplink channel, which is adjacent to the Industrial Scientific and Medical (ISM) band and may cause interference therewith. It is noted that Bluetooth and some Wireless LAN (WLAN) channels fall within the ISM band. In some instances, a Bluetooth error rate can become unacceptable when LTE is active in some channels of Band 7 or even Band 40 for some Bluetooth channel conditions. Even though there is no significant degradation to LTE, simultaneous operation with Bluetooth can result in disruption in voice services terminating in a Bluetooth headset. Such disruption may be unacceptable to the consumer. A similar issue exists when LTE transmissions interfere with GPS. Currently, there is no mechanism that can solve this issue since LTE by itself does not experience any degradation

With reference specifically to LTE, it is noted that a UE communicates with an evolved NodeB (eNB; e.g., a base station for a wireless communications network) to inform the eNB of interference seen by the UE on the downlink. Furthermore, the eNB may be able to estimate interference at the UE using a downlink error rate. In some instances, the eNB and the UE can cooperate to find a solution that reduces interference at the UE, even interference due to radios within the UE itself. However, in conventional LTE, the interference estimates regarding the downlink may not be adequate to comprehensively address interference.

In one instance, an LTE uplink signal interferes with a Bluetooth signal or WLAN signal. However, such interference is not reflected in the downlink measurement reports at the eNB. As a result, unilateral action on the part of the UE (e.g., moving the uplink signal to a different channel) may be thwarted by the eNB, which is not aware of the uplink coexistence issue and seeks to undo the unilateral action. For instance, even if the UE re-establishes the connection on a different frequency channel, the network can still handover the UE back to the original frequency channel that was corrupted by the in-device interference. This is a likely scenario because the desired signal strength on the corrupted channel may sometimes be higher than reflected in the measurement reports of the new channel based on Reference Signal Received Power (RSRP) to the eNB. Hence, a ping-pong effect of being transferred back and forth between the corrupted channel and the desired channel can happen if the eNB uses RSRP reports to make handover decisions.

Other unilateral action on the part of the UE, such as simply stopping uplink communications without coordination of the eNB may cause power loop malfunctions at the eNB. Additional issues that exist in conventional LTE include a general lack of ability on the part of the UE to suggest desired configurations as an alternative to configurations that have coexistence issues. For at least these reasons, uplink coexistence issues at the UE may remain unresolved for a long time period, degrading performance and efficiency for other radios of the UE.

### SUMMARY

According to one aspect of the present disclosure, a method for wireless communication includes receiving a negative-acknowledgement of an initially transmitted fixed block length packet. The method further includes retransmitting a variable block length packet in response to the negative-acknowledgement.

According to another aspect of the present disclosure, a method for wireless communication includes receiving a negative-acknowledgement of an initially transmitted packet. The method further includes retransmitting at least one packet according to hybrid automatic repeat request using superposition coding in response to the negative-acknowledgement.

According to another aspect of the present disclosure, an apparatus for wireless communication includes means for receiving a negative-acknowledgement of an initially transmitted fixed block length packet. The apparatus may also include means for retransmitting a variable block length packet in response to the negative-acknowledgement.

According to another aspect of the present disclosure, an apparatus for wireless communication includes means for receiving a negative-acknowledgement of an initially transmitted packet. The apparatus may also include means for retransmitting at least one packet according to hybrid automatic repeat request using superposition coding in response to the negative-acknowledgement.

According to one aspect of the present disclosure, a computer program product for wireless communication in a wireless network includes a computer readable medium having non-transitory program code recorded thereon. The program code includes program code to receive a negative-acknowledgement of an initially transmitted fixed block length packet. The program code may also include program code to retransmit a variable block length packet in response to the negative-acknowledgement.

According to one aspect of the present disclosure, a computer program product for wireless communication in a wireless network includes a computer readable medium having non-transitory program code recorded thereon. The program code includes program code to receive a negative-acknowledgement of an initially transmitted packet. The program code may also include program code to retransmit at least one packet according to hybrid automatic repeat request using superposition coding in response to the negative-acknowledgement.

According to one aspect of the present disclosure, an apparatus for wireless communication includes a memory and a processor(s) coupled to the memory. The processor(s) is configured to receive a negative-acknowledgement of an initially transmitted fixed block length packet. The processor(s) is also configured to retransmit a variable block length packet in response to the negative-acknowledgement.

According to one aspect of the present disclosure, an apparatus for wireless communication includes a memory and a processor(s) coupled to the memory. The processor(s) is configured to receive a negative-acknowledgement of an initially transmitted packet. The processor(s) is also configured to retransmit at least one packet according to hybrid automatic repeat request using superposition coding in response to the negative-acknowledgement.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates a multiple access wireless communication system according to one aspect.

FIG. 2 is a block diagram of a communication system according to one aspect.

FIG. 3 illustrates an exemplary frame structure in downlink Long Term Evolution (LTE) communications.

FIG. 4 is a block diagram conceptually illustrating an exemplary frame structure in uplink Long Term Evolution (LTE) communications.

FIG. 5 illustrates an example wireless communication environment.

FIG. 6 is a block diagram of an example design for a multi-radio wireless device.

FIG. 7 is graph showing respective potential collisions between seven example radios in a given decision period.

FIG. 8 is a diagram showing operation of an example Coexistence Manager (CxM) over time.

FIG. 9 is a block diagram illustrating adjacent frequency bands.

FIG. 10 is a block diagram of a system for providing support within a wireless communication environment for variable block length coding and/or superposition coding for hybrid automatic repeat request according to one aspect of the present disclosure.

FIG. 11 is a block diagram of a radio access technology configuration illustrating bursty inter-cell interference.

FIG. 12 is a block diagram of a radio access technology configuration illustrating bursty cross-device interference.

FIG. 13 is a block diagram illustrating different rate selection implementations according to some aspects of the present disclosure.

FIG. 14 is a block diagram of a single layer implementation based on measured interference parameters according to some aspects of the present disclosure.

FIG. 15 is a block diagram of a variable block length implementation for hybrid automatic repeat request according to some aspects of the present disclosure.

FIG. 16 is a block diagram illustrating a variable block length coding method for hybrid automatic repeat request according to one aspect of the present disclosure.

FIG. 17 is an exemplary block diagram of a hybrid automatic repeat request superposition implementation according to one aspect of the present disclosure.

FIG. 18 is a block diagram illustrating a method for retransmitting according to a hybrid automatic repeat request using superposition coding according to one aspect of the present disclosure.

FIG. 19 is a diagram illustrating an example of a hardware implementation for an apparatus employing rate adjustment.

### DETAILED DESCRIPTION

Various aspects of the disclosure provide techniques to mitigate coexistence issues in multi-radio devices, where significant in-device coexistence problems can exist between, e.g., the LTE and Industrial Scientific and Medical (ISM) bands (e.g., for BT/WLAN). As explained above, some coexistence issues persist because an eNB is not aware of interference on the UE side that is experienced by other radios. According to one aspect, the UE declares a Radio Link Failure (RLF) and autonomously accesses a new channel or Radio Access Technology (RAT) if there is a coexistence issue on the present channel. The UE can declare a RLF in some examples for the following reasons: 1) UE reception is affected by interference due to coexistence, and 2) the UE transmitter is causing disruptive interference to another radio. The UE then sends a message indicating the coexistence issue to the eNB while reestablishing connection in the new channel or RAT. The eNB becomes aware of the coexistence issue by virtue of having received the message.

The techniques described herein can be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network can implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3^{rd} Generation Partnership Project” (3GPP). CDMA2000 is described in documents from an organization named “3^{rd} Generation Partnership Project 2” (3GPP2). These various radio technologies and standards are known in the art. For clarity, certain aspects of the techniques are described below for LTE, and LTE terminology is used in portions of the description below.

Single carrier frequency division multiple access (SC-FDMA), which utilizes single carrier modulation and frequency domain equalization is a technique that can be utilized with various aspects described herein. SC-FDMA has similar performance and essentially the same overall complexity as those of an OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for an uplink multiple access scheme in 3GPP Long Term Evolution (LTE), or Evolved UTRA.

Referring to FIG. 1, a multiple access wireless communication system according to one aspect is illustrated. An evolved Node B 100 (eNB) includes a computer 115 that has processing resources and memory resources to manage the LTE communications by allocating resources and parameters, granting/denying requests from user equipment, and/or the like. The eNB 100 also has multiple antenna groups, one group including antenna 104 and antenna 106, another group including antenna 108 and antenna 110, and an additional group including antenna 112 and antenna 114. In FIG. 1, only two antennas are shown for each antenna group, however, more or fewer antennas can be utilized for each antenna group. A User Equipment (UE) 116 (also referred to as an Access Terminal (AT)) is in communication with antennas 112 and 114, while antennas 112 and 114 transmit information to the UE 116 over an uplink (UL) 188. The UE 122 is in communication with antennas 106 and 108, while antennas 106 and 108 transmit information to the UE 122 over a downlink (DL) 126 and receive information from the UE 122 over an uplink 124. In a frequency division duplex (FDD) system, communication links 118, 120, 124 and 126 can use different frequencies for communication. For example, the downlink 120 can use a different frequency than used by the uplink 118.

Each group of antennas and/or the area in which they are designed to communicate is often referred to as a sector of the eNB. In this aspect, respective antenna groups are designed to communicate to UEs in a sector of the areas covered by the eNB 100.

In communication over the downlinks 120 and 126, the transmitting antennas of the eNB 100 utilize beamforming to improve the signal-to-noise ratio of the uplinks for the different UEs 116 and 122. Also, an eNB using beamforming to transmit to UEs scattered randomly through its coverage causes less interference to UEs in neighboring cells than a UE transmitting through a single antenna to all its UEs.

An eNB can be a fixed station used for communicating with the terminals and can also be referred to as an access point, base station, or some other terminology. A UE can also be called an access terminal, a wireless communication device, terminal, or some other terminology.

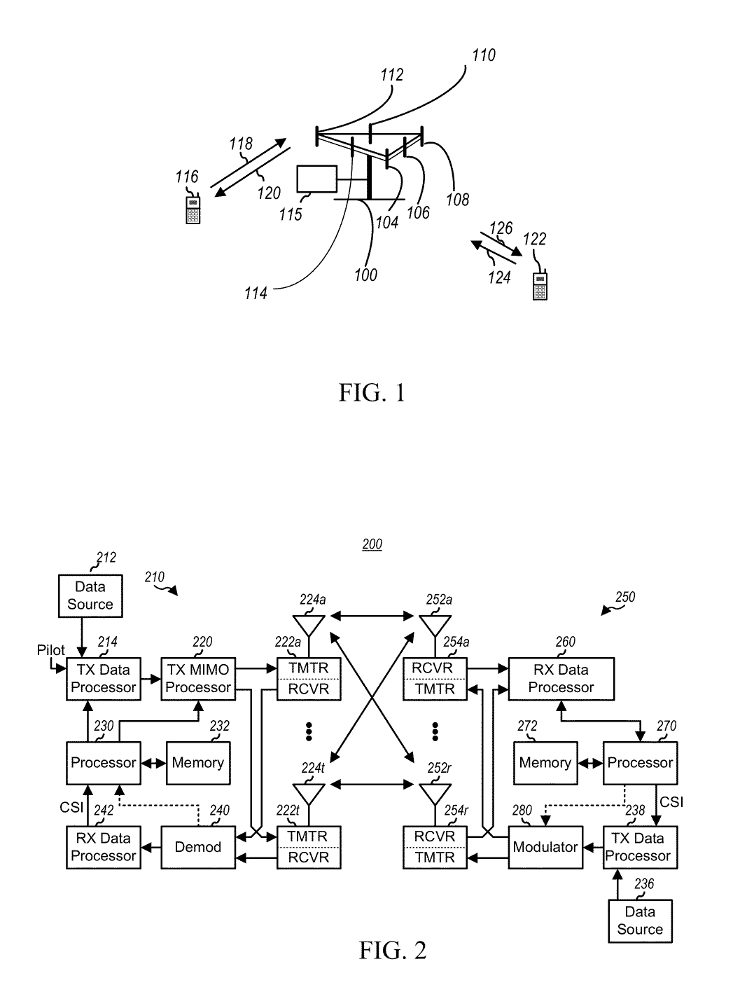

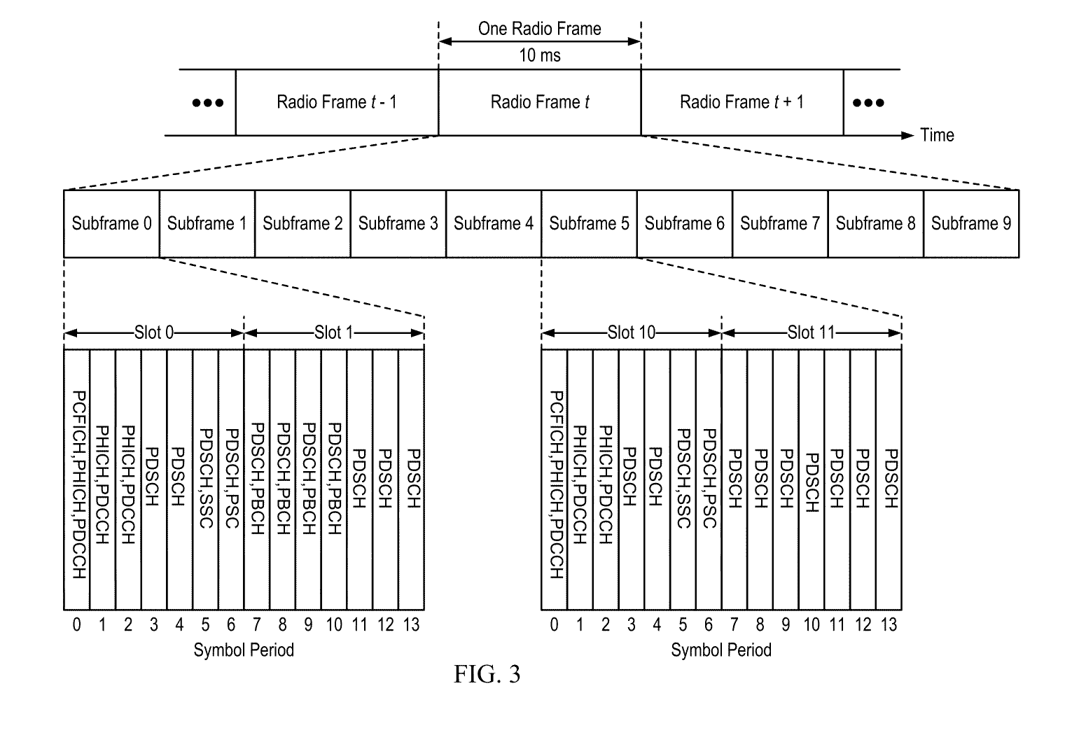

FIG. 2 is a block diagram of an aspect of a transmitter system 210 (also known as an eNB) and a receiver system 250 (also known as a UE) in a MIMO system 200. In some instances, both a UE and an eNB each have a transceiver that includes a transmitter system and a receiver system. At the transmitter system 210, traffic data for a number of data streams is provided from a data source 212 to a transmit (TX) data processor 214.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, wherein N_{S}≦min {N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system supports time division duplex (TDD) and frequency division duplex (FDD) systems. In a TDD system, the uplink and downlink transmissions are on the same frequency region so that the reciprocity principle allows the estimation of the downlink channel from the uplink channel. This enables the eNB to extract transmit beamforming gain on the downlink when multiple antennas are available at the eNB.

In an aspect, each data stream is transmitted over a respective transmit antenna. The TX data processor 214 formats, codes, and interleaves the traffic data for each data stream based on a particular coding scheme selected for that data stream to provide coded data.

The coded data for each data stream can be multiplexed with pilot data using OFDM techniques. The pilot data is a known data pattern processed in a known manner and can be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream can be determined by instructions performed by a processor 230 operating with a memory 232.

The modulation symbols for respective data streams are then provided to a TX MIMO processor 220, which can further process the modulation symbols (e.g., for OFDM). The TX MIMO processor 220 then provides N_{T} modulation symbol streams to N_{T} transmitters (TMTR) 222a through 222t. In certain aspects, the TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from the transmitters 222a through 222t are then transmitted from N_{T} antennas 224a through 224t, respectively.

At a receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{R} “detected” symbol streams. The RX data processor 260 then demodulates, deinterleaves, and decodes each detected symbol stream to recover the traffic data for the data stream. The processing by the RX data processor 260 is complementary to the processing performed by the TX MIMO processor 220 and the TX data processor 214 at the transmitter system 210.

A processor 270 (operating with a memory 272) periodically determines which pre-coding matrix to use (discussed below). The processor 270 formulates an uplink message having a matrix index portion and a rank value portion.

The uplink message can include various types of information regarding the communication link and/or the received data stream. The uplink message is then processed by a TX data processor 238, which also receives traffic data for a number of data streams from a data source 236, modulated by a modulator 280, conditioned by transmitters 254a through 254r, and transmitted back to the transmitter system 210.

At the transmitter system 210, the modulated signals from the receiver system 250 are received by antennas 224, conditioned by receivers 222, demodulated by a demodulator 240, and processed by an RX data processor 242 to extract the uplink message transmitted by the receiver system 250. The processor 230 then determines which pre-coding matrix to use for determining the beamforming weights, then processes the extracted message.

FIG. 3 is a block diagram conceptually illustrating an exemplary frame structure in downlink Long Term Evolution (LTE) communications. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., 7 symbol periods for a normal cyclic prefix (as shown in FIG. 3) or 6 symbol periods for an extended cyclic prefix. The 2 L symbol periods in each subframe may be assigned indices of 0 through 2 L−1. The available time frequency resources may be partitioned into resource blocks. Each resource block may cover N subcarriers (e.g., 12 subcarriers) in one slot.

In LTE, an eNB may send a Primary Synchronization Signal (PSS) and a Secondary Synchronization Signal (SSS) for each cell in the eNB. The PSS and SSS may be sent in symbol periods 6 and 5, respectively, in each of subframes 0 and 5 of each radio frame with the normal cyclic prefix, as shown in FIG. 3. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Cell-specific Reference Signal (CRS) for each cell in the eNB. The CRS may be sent in symbols 0, 1, and 4 of each slot in case of the normal cyclic prefix, and in symbols 0, 1, and 3 of each slot in case of the extended cyclic prefix. The CRS may be used by UEs for coherent demodulation of physical channels, timing and frequency tracking, Radio Link Monitoring (RLM), Reference Signal Received Power (RSRP), and Reference Signal Received Quality (RSRQ) measurements, etc.

The eNB may send a Physical Control Format Indicator Channel (PCFICH) in the first symbol period of each subframe, as seen in FIG. 3. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 3, M=3. The eNB may send a Physical HARQ Indicator Channel (PHICH) and a Physical Downlink Control Channel (PDCCH) in the first M symbol periods of each subframe. The PDCCH and PHICH are also included in the first three symbol periods in the example shown in FIG. 3. The PHICH may carry information to support Hybrid Automatic Repeat Request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 32 or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

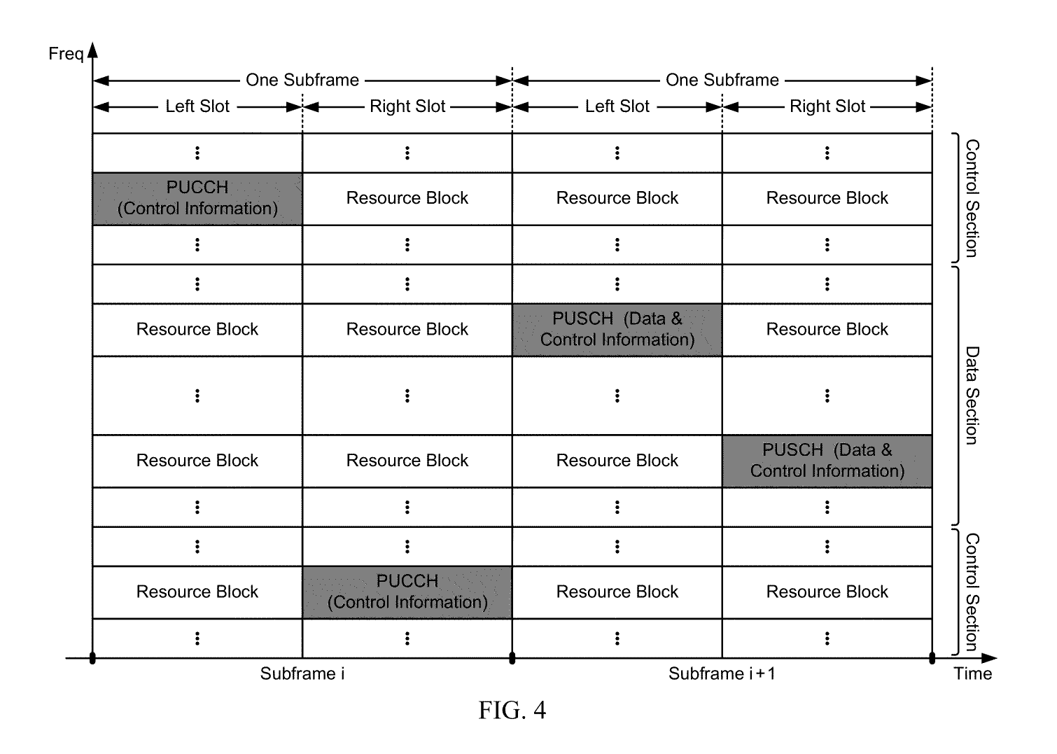

FIG. 4 is a block diagram conceptually illustrating an exemplary frame structure in uplink Long Term Evolution (LTE) communications. The available Resource Blocks (RBs) for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 4 results in the data section including contiguous subcarriers, which may allow a single UE to be assigned all of the contiguous subcarriers in the data section.

A UE may be assigned resource blocks in the control section to transmit control information to an eNB. The UE may also be assigned resource blocks in the data section to transmit data to the eNodeB. The UE may transmit control information in a Physical Uplink Control Channel (PUCCH) on the assigned resource blocks in the control section. The UE may transmit only data or both data and control information in a Physical Uplink Shared Channel (PUSCH) on the assigned resource blocks in the data section. An uplink transmission may span both slots of a subframe and may hop across frequency as shown in FIG. 4.

The PSS, SSS, CRS, PBCH, PUCCH and PUSCH in LTE are described in 3GPP TS 36.211, entitled “Evolved Universal Terrestrial Radio Access (E-UTRA); Physical Channels and Modulation,” which is publicly available.

In an aspect, described herein are systems and methods for providing support within a wireless communication environment, such as a 3GPP LTE environment or the like, to facilitate multi-radio coexistence solutions.

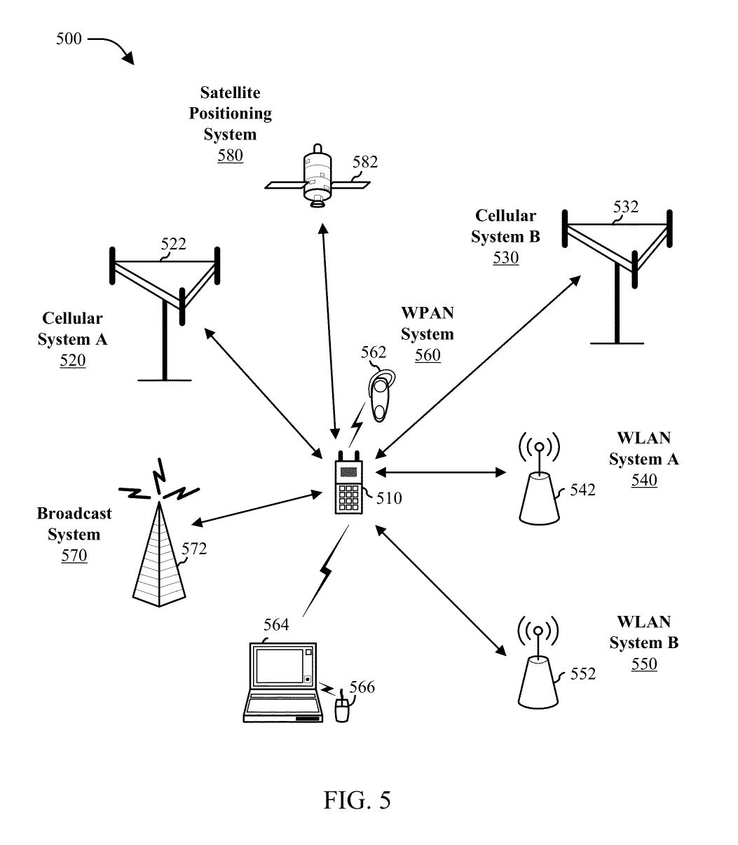

Referring now to FIG. 5, illustrated is an example wireless communication environment 500 in which various aspects described herein can function. The wireless communication environment 500 can include a wireless device 510, which can be capable of communicating with multiple communication systems. These systems can include, for example, one or more cellular systems 520 and/or 530, one or more WLAN systems 540 and/or 550, one or more wireless personal area network (WPAN) systems 560, one or more broadcast systems 570, one or more satellite positioning systems 580, other systems not shown in FIG. 5, or any combination thereof. It should be appreciated that in the following description the terms “network” and “system” are often used interchangeably.

The cellular systems 520 and 530 can each be a CDMA, TDMA, FDMA, OFDMA, Single Carrier FDMA (SC-FDMA), or other suitable system. A CDMA system can implement a radio technology such as Universal Terrestrial Radio Access (UTRA), cdma2000, etc. UTRA includes Wideband CDMA (WCDMA) and other variants of CDMA. Moreover, cdma2000 covers IS-2000 (CDMA2000 1X), IS-95 and IS-856 (HRPD) standards. A TDMA system can implement a radio technology such as Global System for Mobile Communications (GSM), Digital Advanced Mobile Phone System (D-AMPS), etc. An OFDMA system can implement a radio technology such as Evolved UTRA (E-UTRA), Ultra Mobile Broadband (UMB), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3^{rd} Generation Partnership Project” (3GPP). cdma2000 and UMB are described in documents from an organization named “3^{rd} Generation Partnership Project 2” (3GPP2). In an aspect, the cellular system 520 can include a number of base stations 522, which can support bi-directional communication for wireless devices within their coverage. Similarly, the cellular system 530 can include a number of base stations 532 that can support bi-directional communication for wireless devices within their coverage.

WLAN systems 540 and 550 can respectively implement radio technologies such as IEEE 802.11 (WiFi), Hiperlan, etc. The WLAN system 540 can include one or more access points 542 that can support bi-directional communication. Similarly, the WLAN system 550 can include one or more access points 552 that can support bi-directional communication. The WPAN system 560 can implement a radio technology such as Bluetooth (BT), IEEE 802.15, etc. Further, the WPAN system 560 can support bi-directional communication for various devices such as wireless device 510, a headset 562, a computer 564, a mouse 566, or the like.

The broadcast system 570 can be a television (TV) broadcast system, a frequency modulation (FM) broadcast system, a digital broadcast system, etc. A digital broadcast system can implement a radio technology such as MediaFLO™, Digital Video Broadcasting for Handhelds (DVB-H), Integrated Services Digital Broadcasting for Terrestrial Television Broadcasting (ISDB-T), or the like. Further, the broadcast system 570 can include one or more broadcast stations 572 that can support one-way communication.

The satellite positioning system 580 can be the United States Global Positioning System (GPS), the European Galileo system, the Russian GLONASS system, the Quasi-Zenith Satellite System (QZSS) over Japan, the Indian Regional Navigational Satellite System (IRNSS) over India, the Beidou system over China, and/or any other suitable system. Further, the satellite positioning system 580 can include a number of satellites 582 that transmit signals for position determination.

In an aspect, the wireless device 510 can be stationary or mobile and can also be referred to as a user equipment (UE), a mobile station, a mobile equipment, a terminal, an access terminal, a subscriber unit, a station, etc. The wireless device 510 can be cellular phone, a personal digital assistance (PDA), a wireless modem, a handheld device, a laptop computer, a cordless phone, a wireless local loop (WLL) station, etc. In addition, a wireless device 510 can engage in two-way communication with the cellular system 520 and/or 530, the WLAN system 540 and/or 550, devices with the WPAN system 560, and/or any other suitable systems(s) and/or devices(s). The wireless device 510 can additionally or alternatively receive signals from the broadcast system 570 and/or satellite positioning system 580. In general, it can be appreciated that the wireless device 510 can communicate with any number of systems at any given moment. Also, the wireless device 510 may experience coexistence issues among various ones of its constituent radio devices that operate at the same time. Accordingly, device 510 includes a coexistence manager (CxM, not shown) that has a functional module to detect and mitigate coexistence issues, as explained further below.

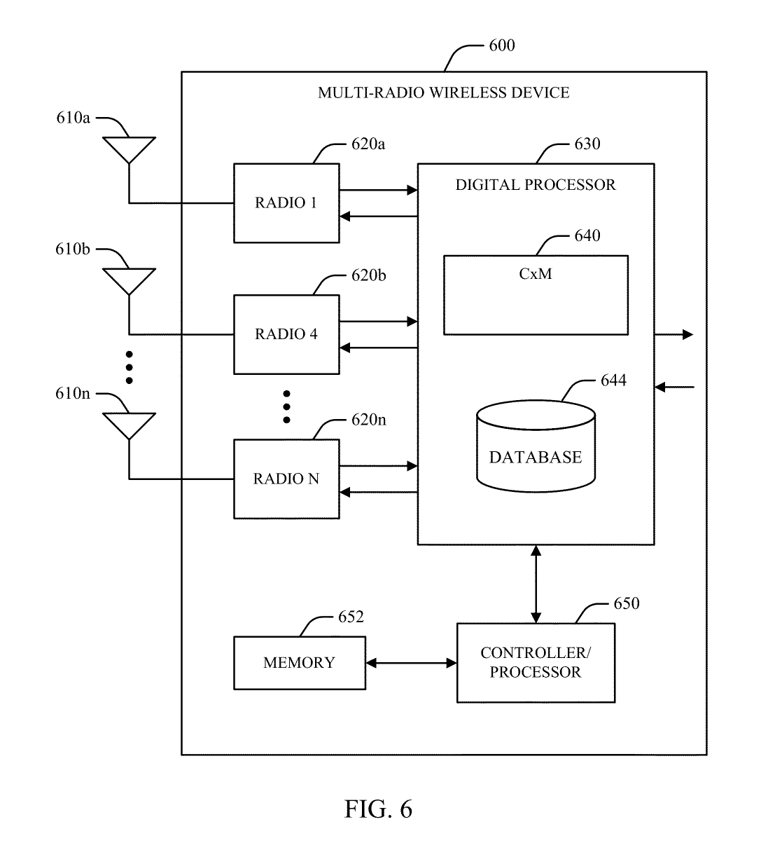

Turning next to FIG. 6, a block diagram is provided that illustrates an example design for a multi-radio wireless device 600 and may be used as an implementation of the radio 510 of FIG. 5. As FIG. 6 illustrates, the wireless device 600 can include N radios 620a through 620n, which can be coupled to N antennas 610a through 610n, respectively, where N can be any integer value. It should be appreciated, however, that respective radios 620 can be coupled to any number of antennas 610 and that multiple radios 620 can also share a given antenna 610.

In general, a radio 620 can be a unit that radiates or emits energy in an electromagnetic spectrum, receives energy in an electromagnetic spectrum, or generates energy that propagates via conductive means. By way of example, a radio 620 can be a unit that transmits a signal to a system or a device or a unit that receives signals from a system or device. Accordingly, it can be appreciated that a radio 620 can be utilized to support wireless communication. In another example, a radio 620 can also be a unit (e.g., a screen on a computer, a circuit board, etc.) that emits noise, which can impact the performance of other radios. Accordingly, it can be further appreciated that a radio 620 can also be a unit that emits noise and interference without supporting wireless communication.

In an aspect, respective radios 620 can support communication with one or more systems. Multiple radios 620 can additionally or alternatively be used for a given system, e.g., to transmit or receive on different frequency bands (e.g., cellular and PCS bands).

In another aspect, a digital processor 630 can be coupled to radios 620a through 620n and can perform various functions, such as processing for data being transmitted or received via the radios 620. The processing for each radio 620 can be dependent on the radio technology supported by that radio and can include encryption, encoding, modulation, etc., for a transmitter; demodulation, decoding, decryption, etc., for a receiver, or the like. In one example, the digital processor 630 can include a coexistence manager (CxM) 640 that can control operation of the radios 620 in order to improve the performance of the wireless device 600 as generally described herein. The coexistence manager 640 can have access to a database 644, which can store information used to control the operation of the radios 620. As explained further below, the coexistence manager 640 can be adapted for a variety of techniques to decrease interference between the radios. In one example, the coexistence manager 640 requests a measurement gap pattern or DRX cycle that allows an ISM radio to communicate during periods of LTE inactivity.

For simplicity, digital processor 630 is shown in FIG. 6 as a single processor. However, it should be appreciated that the digital processor 630 can include any number of processors, controllers, memories, etc. In one example, a controller/processor 650 can direct the operation of various units within the wireless device 600. Additionally or alternatively, a memory 652 can store program codes and data for the wireless device 600. The digital processor 630, controller/processor 650, and memory 652 can be implemented on one or more integrated circuits (ICs), application specific integrated circuits (ASICs), etc. By way of specific, non-limiting example, the digital processor 630 can be implemented on a Mobile Station Modem (MSM) ASIC.

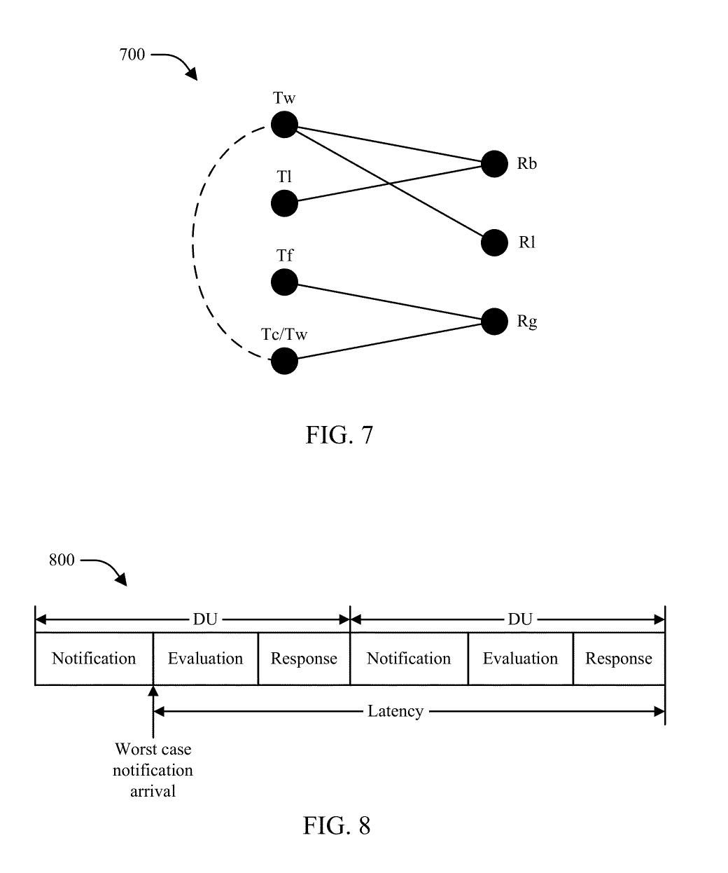

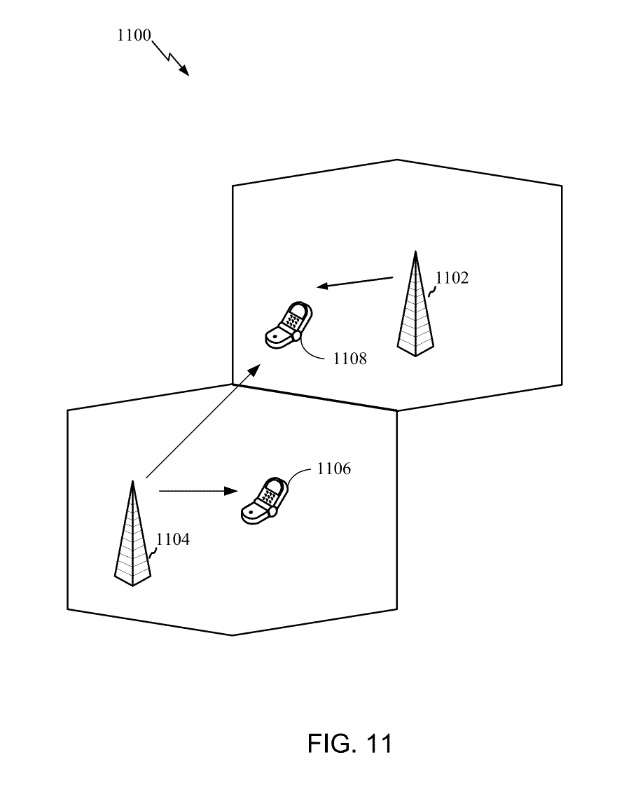

In an aspect, the coexistence manager 640 can manage operation of respective radios 620 utilized by wireless device 600 in order to avoid interference and/or other performance degradation associated with collisions between respective radios 620. coexistence manager 640 may perform one or more processes, such as those illustrated in FIG. 11. By way of further illustration, a graph 700 in FIG. 7 represents respective potential collisions between seven example radios in a given decision period. In the example shown in graph 700, the seven radios include a WLAN transmitter (Tw), an LTE transmitter (Tl), an FM transmitter (Tf), a GSM/WCDMA transmitter (Tc/Tw), an LTE receiver (Rl), a Bluetooth receiver (Rb), and a GPS receiver (Rg). The four transmitters are represented by four nodes on the left side of the graph 700. The four receivers are represented by three nodes on the right side of the graph 700.

A potential collision between a transmitter and a receiver is represented on the graph 700 by a branch connecting the node for the transmitter and the node for the receiver. Accordingly, in the example shown in the graph 700, collisions may exist between (1) the WLAN transmitter (Tw) and the Bluetooth receiver (Rb); (2) the LTE transmitter (Tl) and the Bluetooth receiver (Rb); (3) the WLAN transmitter (Tw) and the LTE receiver (R1); (4) the FM transmitter (TO and the GPS receiver (Rg); (5) a WLAN transmitter (Tw), a GSM/WCDMA transmitter (Tc/Tw), and a GPS receiver (Rg).

In one aspect, an example coexistence manager 640 can operate in time in a manner such as that shown by diagram 800 in FIG. 8. As diagram 800 illustrates, a timeline for coexistence manager operation can be divided into Decision Units (DUs), which can be any suitable uniform or non-uniform length (e.g., 100 μs) where notifications are processed, and a response phase (e.g., 20 μs) where commands are provided to various radios 620 and/or other operations are performed based on actions taken in the evaluation phase. In one example, the timeline shown in the diagram 800 can have a latency parameter defined by a worst case operation of the timeline, e.g., the timing of a response in the case that a notification is obtained from a given radio immediately following termination of the notification phase in a given DU.

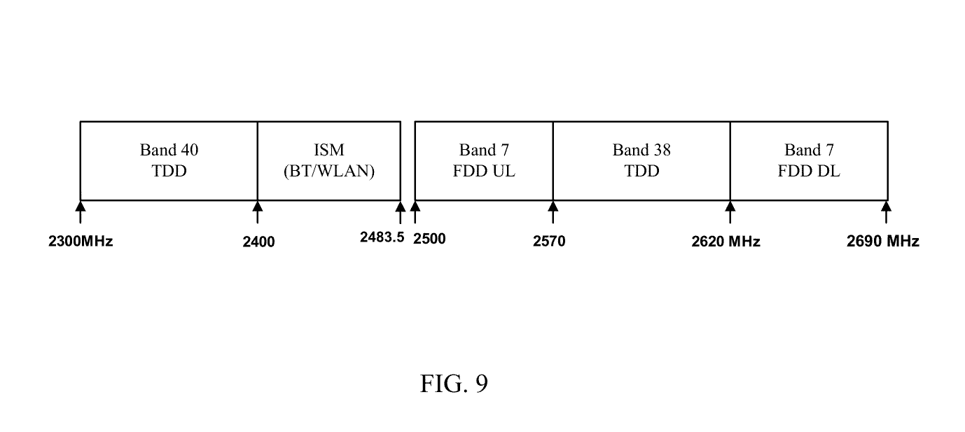

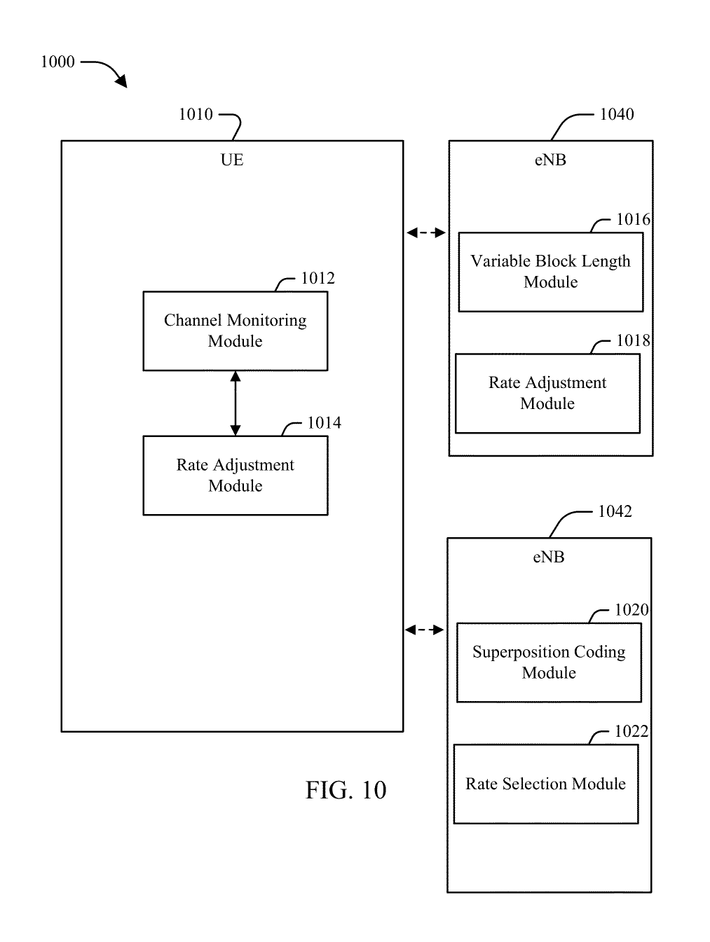

As shown in FIG. 9, Long Term Evolution (LTE) in band 7 (for frequency division duplex (FDD) uplink), band 40 (for time division duplex (TDD) communication), and band 38 (for TDD downlink) is adjacent to the 2.4 GHz Industrial Scientific and Medical (ISM) band used by Bluetooth (BT) and Wireless Local Area Network (WLAN) technologies. Frequency planning for these bands is such that there is limited or no guard band permitting traditional filtering solutions to avoid interference at adjacent frequencies. For example, a 20 MHz guard band exists between ISM and band 7, but no guard band exists between ISM and band 40.

To be compliant with appropriate standards, communication devices operating over a particular band are to be operable over the entire specified frequency range. For example, in order to be LTE compliant, a mobile station/user equipment should be able to communicate across the entirety of both band 40 (2300-2400 MHz) and band 7 (2500-2570 MHz) as defined by the 3rd Generation Partnership Project (3GPP). Without a sufficient guard band, devices employ filters that overlap into other bands causing band interference. Because band 40 filters are 100 MHz wide to cover the entire band, the rollover from those filters crosses over into the ISM band causing interference. Similarly, ISM devices that use the entirety of the ISM band (e.g., from 2401 through approximately 2480 MHz) will employ filters that rollover into the neighboring band 40 and band 7 and may cause interference.

In-device coexistence problems can exist with respect to a UE between resources such as, for example, LTE and ISM bands (e.g., for Bluetooth/WLAN). In current LTE implementations, any interference issues to LTE are reflected in the downlink measurements (e.g., Reference Signal Received Quality (RSRQ) metrics, etc.) reported by a UE and/or the downlink error rate which the eNB can use to make inter-frequency or inter-RAT handoff decisions to, e.g., move LTE to a channel or RAT with no coexistence issues. However, it can be appreciated that these existing techniques will not work if, for example, the LTE uplink is causing interference to Bluetooth/WLAN but the LTE downlink does not see any interference from Bluetooth/WLAN. More particularly, even if the UE autonomously moves itself to another channel on the uplink, the eNB can in some cases handover the UE back to the problematic channel for load balancing purposes. In any case, it can be appreciated that existing techniques do not facilitate use of the bandwidth of the problematic channel in the most efficient way.

Turning now to FIG. 10, a block diagram of a system 1000 for providing support within a wireless communication environment for multi-radio coexistence management is illustrated. In an aspect, the system 1000 can include one or more UEs 1010 and/or eNBs 1040. The UEs 1010 and/or eNBs 1040 may engage in uplink and/or downlink communications, and/or any other suitable communication with each other and/or any other entities in the system 1000. In one example, the UE 1010 and/or eNB 1040 can be operable to communicate using a variety resources, including frequency channels and sub-bands. However, some of the communication resources may collide with other radio resources (e.g., a broadband radio such as an LTE modem). Thus, the UE 1010 and/or eNB 1040 can utilize various techniques for managing coexistence between multiple radios utilized by the UE 1010, as generally described herein.

To mitigate at least the above shortcomings, the UE 1010 can utilize respective features described herein and illustrated by the system 1000 to facilitate support for multi-radio coexistence within the UE 1010. For example, a channel monitoring module 1012 may monitor the quality of a channel. The quality of a channel in good condition may be monitored during an absence of bursty interference. Similarly, the quality of a channel in bad conditions may be monitored during times associated with the bursty interference. A rate adjustment module 1014 may adjust a communication rate based on information received from the channel monitoring module 1012. The modules 1012 and 1014 may, in some examples, be implemented as part of a coexistence manager such as the coexistence manager 640 of FIG. 6.

Further, the eNB 1040 can utilize respective features described herein and illustrated by the system 1000 to facilitate support for variable block length retransmission. For example, a variable block module 1016 may retransmit a fraction of a block length or a variable block length of an initially transmitted packet when a negative acknowledgement of the packet is received. A rate adjustment module 1018 may adjust a communication rate based on the variable block length. The modules 1016 and 1018 may, in some examples, be implemented as part of a processor such as the processor 230 of FIG. 2. The modules 1016 and 1018 and others may be configured to implement the aspects discussed herein.

Further, the eNB 1042 can utilize respective features described herein and illustrated by the system 1000 to facilitate support for superposition coding. Various modules, such as the superposition coding module 1020 and the rate selection module 1022 may be configured to implement aspects of the disclosure discussed. For example, the modules 1020, 1022 and other modules, may be configured to select parameters for implementing rate selection algorithms such as superposition coding in the initial transmission, the retransmission and any subsequent retransmission. The modules 1020 and 1022 may also be configured to implement HARQ retransmission using superposition coding.

In some aspects, the variable block length module 1016, the rate adjustment module 1018, the superposition coding module 1020 and the rate selection module 1022 may be implemented in a same eNB.

As described above, when multiple radio access technologies (RATs) are operating in a single device they may interfere with each other and cause coexistence issues, particularly when one radio is transmitting and another is receiving. However, because the multiple RATs are operating in a single device, a coexistence manager (CxM) of the single device may be able to predict the interference, and thereby mitigate the predictable interference.

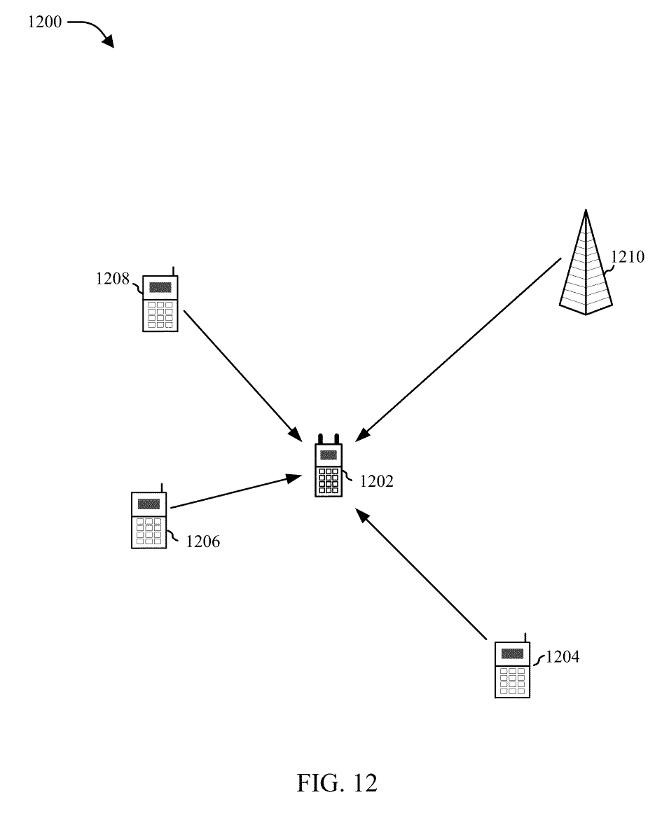

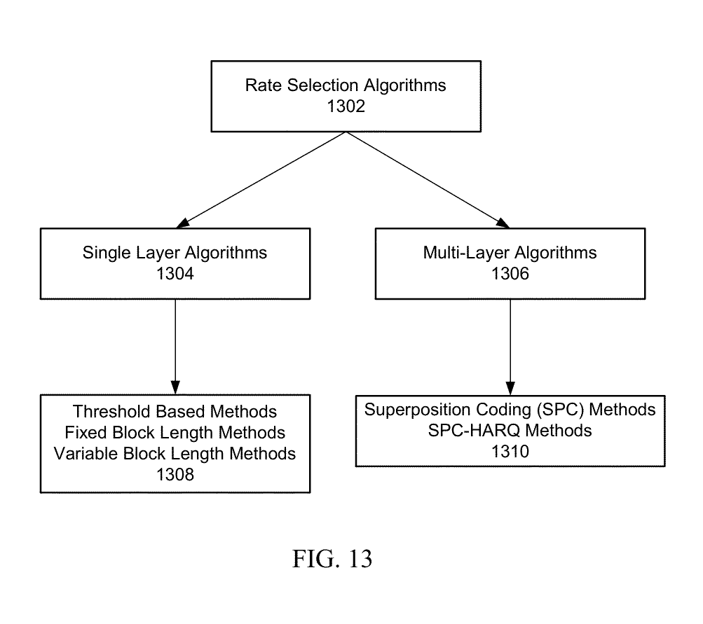

In some communication systems there may be interference when multiple RATs are not in a single device and are operating adjacent to each other. These interference sources may be bursty in nature, such that the interference may be present over a limited time of the entire desired signal. Compensating for bursty interference to a communication channel may present specific difficulties due to the unpredictable nature of the bursty interference. A communication channel may have a good channel capacity without the interference but a bad channel capacity when the interference is active. The average capacity of the channel accounting for the interference may be difficult to actually achieve in view of the interference bursts. It is difficult to design a signaling mechanism with rate control that actually achieves the available capacity of a channel facing bursty interference. Exemplary radio access technology (RAT) configurations that may experience bursty interference are illustrated by the block diagrams of FIGS. 11 and 12.

FIG. 11 is a block diagram 1100 of a RAT configuration illustrating bursty inter-cell interference. In some systems, a first base station 1102 (e.g., access point or eNB) may experience inter-cell interference (e.g., uplink interference) from a neighboring wireless device. The neighboring wireless device may be a second base station 1104 or a device 1106 (e.g., LTE device) connected to the second base station 1104. The second base station may be the same radio access technology (RAT) as the first base station or may be a different RAT. Furthermore, the second base station may be operating on the same channel as the first base station or on an adjacent channel. When a base station, such as the second base station 1104 is in a partial operating mode, interference caused by the second base station may be bursty because the second base station 1104 is not always transmitting.

FIG. 12 is a block diagram 1200 of a RAT configuration illustrating bursty cross-device interference. The RAT configuration may experience bursty interference when an LTE device 1202 operating in bands near an ISM band with an adjacent aggressor WLAN radio (e.g., WLAN or WiFi radio 1204, 1206 or 1208). The LTE device 1202 and the WLAN radio 1204, 1206 or 1208 may be associated with an eNB 1210. The LTE device 1202 may experience bursty interference caused by the WLAN radio 1204, 1206 or 1208 that is bursty in nature. For example, the bursty interference may affect downlink reception in the 1900-1920 MHz band near the International Mobile Telecommunications High Speed Packet Access (IMT HSPA) uplink transmission, and LTE downlink reception on Channels 55 or 56 on the 700 MHz band due to LTE Band 17 uplink transmission. The bursty interference may also occur because of co-channel interference or adjacent channel interference from different RATs.

Some aspects of the present disclosure seek to mitigate bursty interference based on a rate selection and/or rate adaptation implementations. The rate selection implementation may be applied at a transmitter of a RAT device (e.g., eNB). Exemplary rate selection implementations are illustrated by the block diagram of FIG. 13.

FIG. 13 is a block diagram 1300 illustrating different rate (e.g., transmission rate) selection implementations according to some aspects of the present disclosure. The rate selection implementation at block 1302 may be divided into a single layer implementation 1304 and a multi-layer implementation 1306. The single-layer implementation may include a threshold based implementation, a fixed block length implementation and a variable block length implementation, as shown in block 1308. The multi-layer implementation includes a superposition coding implementation and a superposition coding HARQ implementation, as shown in block 1310.

Some aspects of the disclosure select transmission rate to improve or maximize throughput of a system, such that the system is robust to interference. Equations 1, 2 and 3 below illustrate examples of transmission rate selection implementations. For example, an improved or maximum throughput based rate selection (MTBRS) implementation is illustrated by equation 1. Equation 1 takes into account a rate (R) that is currently used. The rate R may be determined as follows: R=n/L, where n represents a number of encoded bits and L represents a number of complex symbols or block length of a codebook C which is a subset of a universe of codes C^{L} (i.e., C⊂C^{L}). In this case, n bits are encoded in L complex symbols. For a given interference channel, the overall throughput is given by T(R). An improved rate or maximum rate R* may be determined as follows:

R*=argmax T(R) Equation 1

where argmax T(R) represents an argument of a maximum overall throughput The maximum or improved throughput T* may be a function of the improved rate R* (i.e., T*=T(R*)).

An outage event based rate selection (OEBRS) implementation is illustrated by equation 2. The outage event may occur when a decoder at a receiver (e.g., UE) fails to decode a transmitted codeword after a number of transmissions (e.g., M). An improved or maximum transmission rate R** may be selected to meet a certain outage probability based on a delay constrain application. For example, the improved rate R** may be a maximum rate selected such that an outage criteria δ(R) for a particular interference channel is less than a threshold outage δ, as shown in Equation 2.

R**=max R Equation 2
such that δ(R)≦δ

The maximum or improved throughput T** may be a function of the improved rate R** (i.e., T**=T(R**)).

An outage constrained maximum throughput based rate selection (OCMTBRS) implementation is illustrated by equation 3. The OCMTBRS implementation may be similar to the MTBRS implementation where the transmission rate is selected to maximize or improve the throughput. According to this implementation, a rate R*** is determined to maximize or improve the throughput function based on a same outage criteria 6(R). According to the OCMTBRS implementation, the rate R*** that maximizes the throughput may be defined as follows:

R***=argmax T(R) Equation 3
such that δ(R)≦δ

The improved throughput T*** may be a function of the determined rate R*** (i.e., T***=T(R***)).

Some aspects of the present disclosure may improve communication performance based on measurements of interference (e.g., bursty interference) parameters or characteristics. Rate selection implemented at the transmitter (e.g., of eNB) may be improved when the transmitter is aware of the interference parameters sensed by the receiver (e.g., UE). The receiver measures the interference parameters and sends the results of the measurement to the transmitter. The transmitter may use the measurements to select a desired rate selection implementation and the parameters for the rate selection implementation. For example, the receiver may measure a parameter Pₐ of a burst interference and provide an estimate Pₐ of the measurement to the transmitter to facilitate rate selection. Some of the measured parameters of the interference channel (e.g., N-jammer interference channel) include duty cycle α={α₁, . . . , α_{N}}, power levels of all jammers I_{N}, noise level Nₒ and signal power level P. An exemplary rate selection implementation based on measured interference parameters is illustrated by the block diagram of FIG. 13.

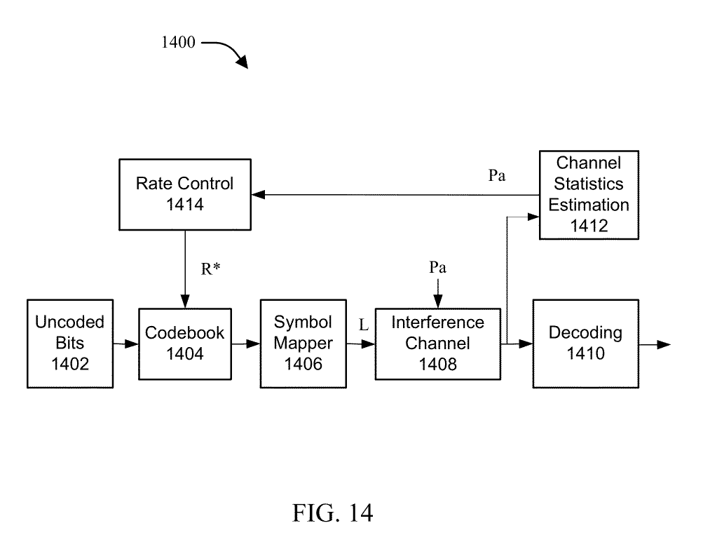

FIG. 14 is a block diagram 1400 of a single layer implementation based on measured interference parameters according to some aspects of the present disclosure. A transmitter may transmit a codeword or encoded bits to a receiver. Prior to transmitting, uncoded bits 1402 are encoded based on a codebook 1404 of the receiver. For example, the transmitter chooses a code rate and a codeword size in accordance with the codebook 1404. The selection may increase the likelihood that the transmitted information is decoded. The encoded bits are then forwarded to a symbol mapper 1406 to map the encoded bits. For example, the symbol mapper 1406 maps n encoded bits to symbols of block length L.

An output codeword of the symbol mapper 1406 is transmitted over an interference channel 1408 to the receiver. The codeword may be transmitted at an initial rate R. The transmitted codeword may be detected or decoded at a detection/decoding device 1410 at the receiver. The interference channel parameters Pₐ may be measured or estimated by the receiver and fed back to the transmitter. For example, a channel statistics estimation device 1412 may estimate the interference parameters of the channel 1408 and feed the estimation back to a rate control device 1414. The rate control device 1414 selects a current transmission rate, e.g. R*, for transmitting the codeword based at least in part on the estimate of the interference parameters Pₐ. The selected rate R*, may be communicated to the codebook. In some aspects, the rate may be selected based on an outage event. For example an outage event may occur when a rate R (=n/L) is greater than or equal to the a channel capacity C (i.e., R≧C.) The probability of the outage at a rate R may be represented by δ(R)=Pr(R≧C), where Pr(R≧C) is the probability of R≧C.

In some aspects, an improved channel (e.g., 1-jammer channel) may be achieved by randomly selecting a good transmission rate (C_{g}) (i.e., channel capacity when there is no interference), and randomly selecting a bad transmission rate (C_{b}) (i.e., channel capacity when there is interference). In one aspect, the random selection may be according to a maximum throughput based rate selection (MTBRS) implementation. In this implementation, when a duty cycle α of the interference is less than or equal to a threshold duty cycle α*, a transmission rate R* equal to C_{g} is randomly selected. In this case, the selected transmission rate Cg may be given by the following equation:

C_{g}=1−C_{b}/C_{g} Equation 4

When the duty cycle α of the interference is greater than the threshold duty cycle α* a transmission rate R* of C_{b} is randomly selected.

In one aspect, the random selection may be according to an OEBRS and/or OCMTBRS implementation. In this case, when the duty cycle α of the interference is less than an outage value δ (i.e., α<δ) a transmission rate R** or R*** equal to C_{g} is randomly selected. However, when the duty cycle α of the interference is greater than or equal to the outage value δ (i.e., α≧δ) a transmission rate R** or R*** equal to C_{b} is randomly selected.

Table 1 illustrates a comparison of throughput, outage and transmission rate of OEBRS and MTBRS implementations for a 1-jammer channel. The throughput, outage and transmission rate of the OEBRS implementation are determined based on a relationship between the duty cycle α of the interference and an outage value δ. The throughput, outage and transmission rate of the MTBRS implementation are determined based on a relationship between the duty cycle α of the interference and a threshold duty cycle α*.

TABLE 1

| OEBRS/MTBRS | Throughput | Outage | Rate |
|---|---|---|---|
| α < δ/α < α* | T = (1 − α ) C_{g} | δ = α | R = C_{g} |
| α ≧ δ/α ≧ α* | T = C_{b} | δ = 0 | R = C_{b} |

Regarding the OEBRS implementation, when the duty cycle α is less than the outage value δ, the throughput T is given by (1−α) C_{g}, the outage value δ is given by the duty cycle α, and the transmission rate R is given by the good transmission rate C_{g}. Similarly, regarding the MTBRS implementation, when the duty cycle α is less than the threshold duty cycle α*, the throughput T is given by (1−α) C_{g}, the outage value δ is given by the duty cycle α, and the transmission rate R is given by the good transmission rate C_{g}.

Regarding the OEBRS implementation, when the duty cycle α is greater than or equal to the outage value δ, the throughput T is given by the bad transmission rate C_{b}, the outage value δ is equal to 0, and the transmission rate R is given by the bad transmission rate C_{b}. Similarly, regarding MTBRS implementation, when the duty cycle α is greater than or equal to the threshold duty cycle α*, the throughput T is given by the bad transmission rate C_{b}, the outage value δ is equal to 0, and the transmission rate R is given by the bad transmission rate C_{b}.

### Variable Block Length Coding for Hybrid Automatic Repeat Request

Packet transmission failure may occur in the presence of interference, particularly bursty interference, such as that caused by an aggressor radio access technology (RAT) such as WiFi, etc. Conventionally, a transmitter may operate a hybrid automatic repeat request (HARQ) process, such that when a transmitted packet is not decoded, the transmitter repeats the transmission and continues to add redundancy until the packet is decoded. For example, the conventional HARQ process is implemented by transmitting a packet of fixed block length L. When the packet is not properly received or not decoded, information associated with the packet is retransmitted. However, the retransmitted information is of the same fixed block length as the initially transmitted packet. The retransmitted information may be the same initially transmitted packet or some redundancy parity bit. Retransmitting information that is the same fixed block length as the initially transmitted packet is inefficient.

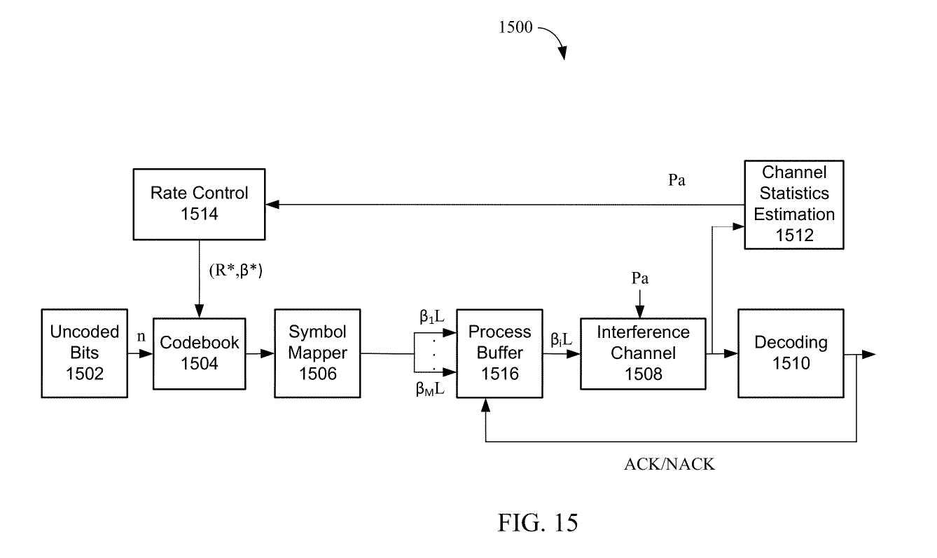

Offered is a method for improving the retransmission of information associated with the HARQ process using a variable block length retransmission. In one aspect of the disclosure, the retransmitted information of the HARQ process is a fraction of the fixed block length L of the initially transmitted packet. To improve retransmission, the eNB may utilize respective features described herein and illustrated by the system 1000 to facilitate variable block length retransmission. As noted, the modules 1016 and 1018 may, in some examples, be implemented as part of a processor such as the processor 230 of FIG. 2. The modules 1016, 1018 and others may be configured to implement the features discussed herein. Further, an exemplary variable block length implementation for HARQ process is illustrated by the block diagram of FIG. 15.

FIG. 15 is a block diagram 1500 of a variable block length implementation of a HARQ process according to some aspects of the present disclosure. In this aspect, a transmitter may transmit a packet including a codeword or encoded bits to a receiver. Prior to transmitting the codeword, uncoded bits 1502, for example, are encoded based on a codebook 1504 associated with the transmitter. The encoded bits are then forwarded to a symbol mapper 1506 to map the encoded bits. For example, the symbol mapper 1506 maps n encoded bits to symbols of block length L. The symbol mapped codeword of block length L may be initially transmitted at an initial transmission rate given by:

R=n/L Equation 5

where R is the initial transmission rate and n is the number of encoded bits in the block length L

The output codeword of the symbol mapper 1506 is transmitted over the interference channel 1508 to the receiver. In some aspects, the output codeword (i.e., symbol mapped codeword) may be forwarded to a buffer 1516 before being transmitted over the interference channel 1508. The symbol mapped codeword may be divided into fractions prior to being received at the buffer 1516. For example, the symbol mapped codeword of block length L may be divided into fractions of codewords. Each fraction of the codeword may have a block length that is a fraction of the block length L. For example, the fractions of block length L may be represented by β₁L . . . β_{M}L, where β is a fractional number between 0 and 1, and M is a number of retransmissions or a predefined number.

Initially, a symbol mapped codeword of block length L may be transmitted. The symbol mapped codeword of block length L may be decoded at a decoding device 1510 at the receiver. The parameters of the interference channel 1508 may be measured by the receiver and fed back to the transmitter. For example, a channel statistics estimation device 1512 may estimate the interference parameters of the channel 1508 and feed the estimation back to a rate control device 1514. The rate control device 1514 may select a current transmission rate (e.g., R*), for retransmission based at least in part on the estimate of the interference parameters. The selected rate R* may be communicated to the codebook 1504.

A negative acknowledgement (NACK) of the HARQ process may be received by the transmitter indicating that the initially transmitted codeword of block length L was not received or was erroneously received. In response to the NACK, the transmitter may retransmit a corresponding codeword at a fraction of the block length L of the initially transmitted codeword. For example, instead of retransmitting the corresponding codeword at a fixed block length L, the corresponding codeword is retransmitted at a fraction, βᵢ, of the block length L (i.e., βᵢL). In some aspects, βᵢ is a fraction that ranges from 0 to 1 such that βᵢL represents a variable block length. The variability of the block length L may be based on βᵢ belonging to the following set:

βᵢ∈(0,1] Equation 6

where i represents the number of retransmissions to combat interference. In this aspect, βᵢ may be selected for each retransmission up to a desired number of retransmissions (e.g., maximum number M of retransmissions) to combat the interference. In some aspects of the disclosure, the fraction β (e.g., β*) may be selected by the rate control device 1514. The selected fraction β may be based at least in part on the estimate of the interference parameters.

Equations 7, 8 and 9 illustrate a variable block length asymptotic performance to determine a desires throughput. In one aspect, the variable block length asymptotic performance is given by the following equations:

$$\begin{matrix}PR ( error \vert R < {\sum }_{i = 1}^{M} β iCi ) = 0 & Equation 7 \\ PR ( error \vert R \geq {\sum }_{i = 1}^{M} β iCi ) = 1 & Equation 8 \\ PR ( undetected error ) = 0 & Equation 9\end{matrix}$$

where M represents a number of retransmissions, Cᵢ represents the channel capacity for the i^{th} slot or layer, βᵢ represents the fraction of L symbols that are transmitted over the i^{th} layer and PR represents the probability of error based on the rate R

$$\begin{matrix} T ( R , β ) = \frac{( 1 - δ ( R , β ) ) R}{\overline{S} ( R , β )} & Equation 10 \\ δ ( R , β ) = Pr ( R \geq {\sum }_{i = 1}^{M} β iCi ) & Equation 11 \\ \overline{S} ( R , β ) = Pr ( R < C 1 ) + {\sum }_{i = 2}^{M - 1} ( {\sum }_{j = 1}^{i} β j ) Pr ( {\sum }_{j = 1}^{i - 1} β iCi \leq R < {\sum }_{j = 1}^{i} β iCi ) + ( {\sum }_{j = 1}^{M} β j ) Pr ( R \geq {\sum }_{i = 1}^{M - 1} β iCi ) & Equation 12\end{matrix}$$

where β is a fraction or a fractional vector for varying the block length L and may be represented by {β₂, . . . , β_{M}}, δ(R,β) represents an outage probability, S̅(R,β) represents an average amount of resources allocated for transmitting a packet (the allocated resources include resources allocated for a number (e.g., M) retransmissions), T(R, β) represents throughput and (1−δ(R,β))R represents an actual number of bits.

While equation 10, 11 and 12 define a matrix, the following equations (i.e., 13, 14 and 15) represent a variable block length HARQ MTBRS improvement or optimization. For example, the equations define the rate R* and the fraction β*, that maximizes or improves the throughput T(R) as follows:

(R*,β*)=argmax T(R) Equation 13

where R, β are subject to

β∈(0,1]^{M-1} Equation 14

T*=T(R*,β*) Equation 15

The improvement or optimization are based on R and β, which are vectors of continuous variables. In some aspects, β is a vector of size M−1. The improved throughput is a function of the rate R* and the fraction β*.

For a N (e.g., 1) jammer channel in which M is equal to 2, the fraction β* of the variable block length HARQ MTBRS implementation may be represented as follows:

β*∈{ε−1,1−ε⁻¹,1} when ε<2 and Equation 16

β*∈{1−ε⁻¹,1} otherwise Equation 17

where ε represents a ratio of a good transmission rate C_{g} to a bad transmission rate C_{g}. This implementation continuously improves or optimizes transmission by allowing β* to be allocated one of a number of values (e.g., at most three values). In some aspects, as ε become larger (e.g., as ε→∞, the variable block length implementation yields β* closer to 1 (i.e., fixed block length). When ε tends to infinity, the implementation may be represented as follows:

lim_{ε→∞}E(C)/Cg=1−α Equation 18

In some aspects, transmitting once at a rate of Cg may be specified or optimal for a very large ε.

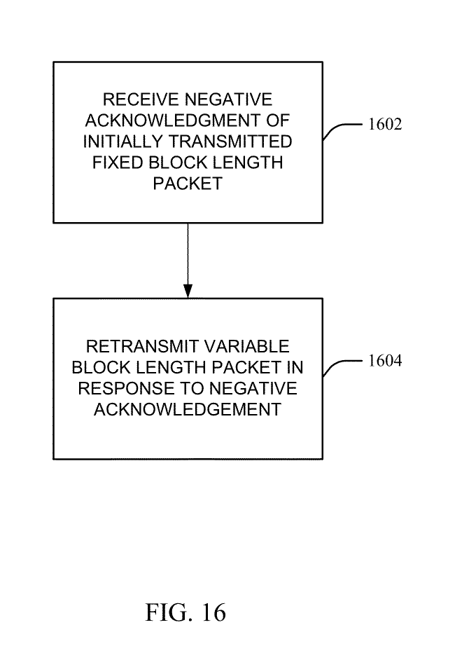

FIG. 16 is a block diagram illustrating variable block length coding method for hybrid automatic repeat request according to one aspect of the present disclosure. A transmitter may receive a negative-acknowledgement of an initially transmitted fixed block length packet, as shown in block 1602. For example, the negative-acknowledgement may be received by a process buffer of the transmitter. The transmitter may retransmit a variable block length packet in response to the negative-acknowledgement, as shown in block 1604.

### Superposition Coding

Typically, superposition coding is a technique where at least two data packets may be combined at a transmitter as a superposition coded packet and transmitted with scaled power to at least two users at a moment in time. The signals to different users are superimposed on each other and transmitted with different powers in the same data packet. In this aspect, a transmitter may transmit two codewords, S1 and S2 directed to the same user, such that S1 may be a codeword that is decoded even when there is a bad channel, and S2 may only be decoded when received via a good channel and after a receiver cancels the decoding of S1. Thus, the receiver may decode S1 at all times (even when the receiver has a bad channel), and the receiver may decode S2 when the receiver has a good channel. Accordingly, the transmitter does not have to know the current channel conditions because the transmitter transmits both S1 and S2.

Further techniques for superposition coding are described in U.S. Provisional Patent Application No. 61/602,816 filed Feb. 24, 2012 entitled “MULTI-RADIO COEXISTENCE,” in the names of KADOUS, et al., the disclosure of which is incorporated by reference in its entirety as noted above.

### Superposition Coding Hybrid Automatic Repeat Request Retransmission

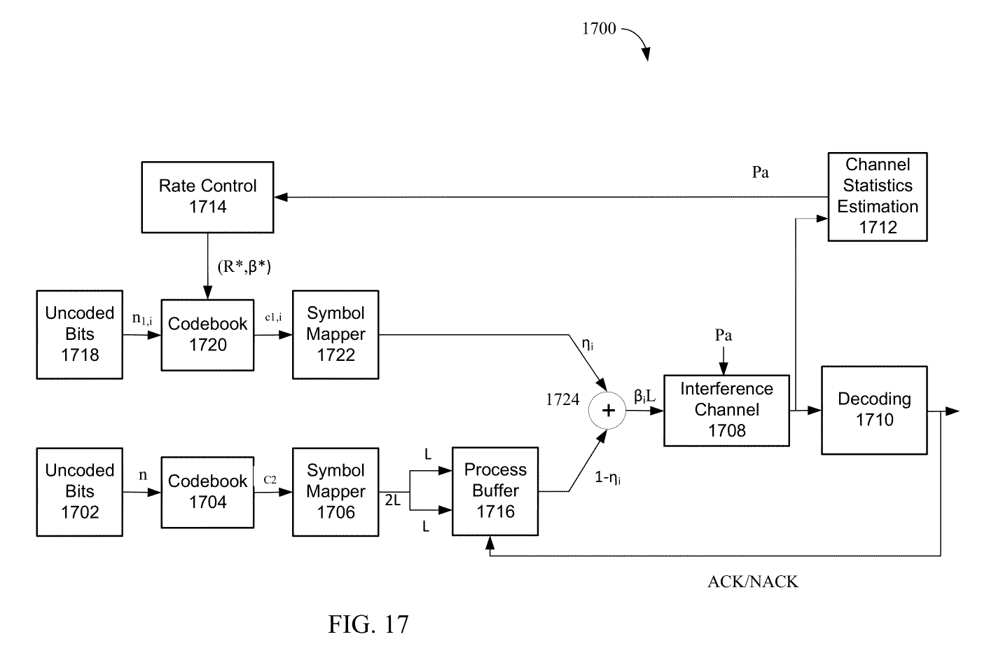

Packet transmission failure may occur in the presence of interference, particularly bursty interference, such as that caused by an aggressor radio access technology (RAT) such as WiFi, etc. Typically, a transmitter or eNB may operate a hybrid automatic repeat request (HARQ) process, such that when a transmitted packet is not decoded, the transmitter repeats the transmission and continues to add redundancy until the packet is decoded. This redundant retransmission, however, is ineffective. An exemplary HARQ superposition coding scheme may be implemented to mitigate ineffective redundant retransmission, as illustrated in FIG. 17.

FIG. 17 is an exemplary block diagram of a HARQ superposition implementation according to one aspect of the present disclosure. In this aspect, superposition coding may be implemented in accordance with a hybrid automatic repeat request (HARQ) process to improve retransmission of packets. An eNB may utilize superposition coding to improve channel capacity. For example, the eNB may transmit two or more codewords, e.g., 51 and S2, directed to the same user. In some aspects, the first codeword 51 may decoded even when there is a bad channel, and the second codeword S2 is only decoded when received via a good channel and after the receiver cancels the decoding of S1. The codewords 51 and S2 may be based on two or more uncoded bits (e.g., first uncoded bits 1718 and second uncoded bits 1702, respectively).

Prior to transmitting the two codewords (51 and S2), the first and second uncoded bits 1718 and 1702, for example, are processed through two separate transmitting chains. The first uncoded bits 1718 may be encoded based on a first codebook 1720 associated with a first transmit chain to generate the code word 51. A number of bits, e.g., n_{1,i} bits, of the first uncoded bits 1718 may be encoded in L complex symbols according to the first codebook 1720. The output of the first codebook 1720 is forwarded to a first symbol mapper 1722, which maps the first codeword 51. For example, the first symbol mapper maps the encoded bits of the first codeword 51 to symbols of block length L. The first codeword 51 is transmitted to the first symbol mapper 1722 over of the first transmit chain. The first codeword S1 may be transmitted at a transmission rate equal to a channel capacity c_{1,i}. A fraction ηᵢ of a total transmission power P may be allocated for transmission of the first codeword S1 over the interference channel 1708.

Similarly, the second uncoded bits 1702 may be encoded based on a second codebook 1704 associated with a second transmit chain to generate the code word S2. In this case, n₂ bits of the second uncoded bits 1702 are encoded in L complex symbols according to the second codebook 1704. The output of the second codebook 1704 is forwarded to a second symbol mapper 1706, which maps the second codeword S2. For example, the second symbol mapper maps the encoded bits of the codeword S2 to symbols of block length 2L. The second codeword S2 is transmitted to the second symbol mapper 1706 over the second transmit chain at a transmission rate equal to a channel capacity C₂. A fraction 1−ηᵢ of a total transmission power P may be allocated for transmission of the second codeword S2 over the interference channel 1708.

The output of the second symbol mapper 1706 may be forwarded to a process buffer 1716 before being transmitted over the interference channel 1708. In one aspect of the present disclosure, the second codeword S2 may be split into two or more mapped symbols of codewords prior to being received at the process buffer 1716. For example, the codeword S2 may be separated into two mapped symbols such that each of the two mapped symbols has a block length that is a fraction of the total block length 2L. In this case, the block length of each of the separated codewords is equal to L. In one aspect of the present disclosure, the output codeword S1 of the first symbol mapper 1722 and the output codeword S2 of the process buffer 1716 may be forwarded to an adding device 1724. The adding device 1724 combines the codewords S1 and S2 prior to transmission over the interference channel 1708. For example, the codewords S1 and S2 are superimposed on each other and transmitted with different powers (i.e., ηᵢP and (1−ηᵢ)P) in a same data packet.

In some aspects of the disclosure, the codewords S1 and/or S2 may be decoded by a decoding device 1710 at the receiver. The decoding device 1710 may be configured to decode a single codeword (e.g., S1 or S2) or the combined codeword (e.g., S1 and S2) based on the parameters Pa of the channel 1708. For example, the decoding device 1710 may decode S1 at all times (even when the receiver has a bad channel). The decoding device may also decode S2 when the receiver has a good channel. As a result, an eNB does not have to know the current channel conditions because the transmitter transmits both S1 and S2.

The parameters Pₐ of the interference channel 1708 may be measured by the receiver and fed back to the transmitter. For example, a channel statistics estimation device 1712 may estimate the interference parameters Pₐ of the interference channel 1708 and feed the estimation back to a rate control device 1714. The rate control device 1714 may select a current transmission rate R*, for example, to transmit the first codeword S1. The rate control device may also select a fraction, e.g., η*, of the total transmission power P for transmission of the first codeword S1. The selection or determination of the transmission rate and power for the first codeword S1 may be based at least in part on the estimate of the interference parameters. The selected rate R*, and the selected transmission power may be communicated to the first codebook 1720 for transmission of the first codeword S1.

A negative acknowledgement (NACK) of a HARQ process may be received by the transmitter indicating that the initially transmitted codewords S1 and/or S2 were not received or were erroneously received. The codewords S1 and/or S2 may be retransmitted according to the superposition implementation described herein. The receiver may forward the NACK to the process buffer 1716 of the transmitter. For example, instead of retransmitting a single codeword corresponding to the initially transmitted codeword, the transmitter may retransmit two or more codewords (e.g., S1 and S2) simultaneously in response to the NACK. The number of codewords transmitted simultaneously may be M₁. The codewords may be retransmitted for a predefined number of times (e.g., a maximum of M₂ times). In addition, the transmission rate and/or power of the simultaneously retransmitted codewords (e.g., S1 and S2) may be based at least in part on the estimated channel parameters.

The eNB may repeat the transmission using the following superposition coding implementations. In the superposition equations below, two signals xᵢ and x₂ are allocated different transmission power (i.e., ηᵢP and (1−ηᵢ)P) for transmission and transmitted simultaneously. The signals may be superimposed in a single signal yₘ. The resulting transmission rate R_{1,i} is a function of ηᵢ.

$$\begin{matrix}{y}_{m}^{i} = \sqrt{η P} {x}_{i , m}^{i} + \sqrt{( 1 - {η}_{i} ) P} {x}_{2 , m}^{i} + {\sum }_{j = 1}^{N} {b}_{j , m} {w}_{j , m} + {v}_{m} & Equation 19 \\ {R}_{1 , i} = R ( {η}_{i} ) = {log}_{2} ( 1 + \frac{{η}_{i} P}{( 1 - {η}_{i} ) P + {\sum }_{j} {I}_{j} + N} ) & Equation 20\end{matrix}$$

In some aspects, a first layer of all transmission is decoded under all conditions. To calculate an HARQ superposition coding throughput, a channel capacity Cᵢ(ηᵢ) which denotes a channel capacity after decoding and subtracting CW_{i,1}, (the i, 1 codeword) may be specified, where i belongs to the set {1,2}, i.e., iε{1,2}.

The hybrid superposition coding HARQ throughput T, may be a function of η₁ and η₂, where η₁ is allocated to a first layer and η₂ is assigned to a second layer. The hybrid superposition coding HARQ throughput may be calculated as follows:

$$\begin{matrix}T ( {R}_{2} , {η}_{1} , {η}_{2} ) = \frac{R ( {η}_{1} ) + Pr ( {R}_{2} \geq {C}_{1} ( {η}_{1} ) ) R ( {η}_{2} )}{\overline{m} ( {R}_{2} , {η}_{1} )} + \frac{{R}_{2} ( 1 - δ ( {R}_{2} , {η}_{1} , {η}_{2} ) )}{\overline{m} ( {R}_{2} , {η}_{1} )} & Equation 21 \\ δ ( {R}_{2} , {η}_{1} , {η}_{2} ) = Pr ( {R}_{2} \geq {C}_{1} ( {η}_{1} ) + {C}_{2} ( {η}_{2} ) & Equation 22 \\ \overline{m} ( {R}_{2} , {η}_{1} ) = 2 - Pr ( {R}_{2} < {C}_{1} ( {η}_{1} ) ) & Equation 23\end{matrix}$$

where δ(R₂,η₁,η₂) represents an outage probability for a second layer, Pr represents a probability of the outage and m̅(R₂,η₁) represents an average number of retransmissions

In some aspects of the disclosure HARQ superposition coding may be applied to rate selection implementations. For example, HARQ superposition coding may be applied to the MTBRS implementation. The parameters R₂, η₁ and η₂ may be selected for improvement or optimization according to the following equations:

(R₂*,η₁*,η₂*)=argmax T(R₂,η₁,η₂) Equation 24

T*=(R₂*,η₁*,η₂) Equation 25

where R₂* is a function of η₁* and η₂*.

In this case, the improvement or optimization may be implemented according to numerical optimization techniques. The resulting throughput T* is a function of R*₂, η*₁ and η*₂.

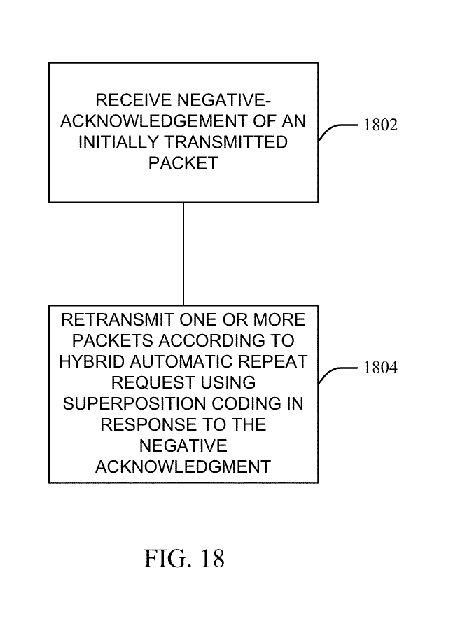

FIG. 18 is a block diagram illustrating a method for retransmitting according to hybrid automatic repeat request using superposition coding according to one aspect of the present disclosure. A transmitter may receive a negative-acknowledgement of an initially transmitted packet, as shown in block 1802. For example, the negative-acknowledgement may be received by a process buffer of the transmitter. In some aspects of the disclosure, the transmitter is included in the eNB. The transmitter may retransmit at least one packet according to hybrid automatic repeat request using superposition coding in response to the negative-acknowledgement, as shown in block 1804.

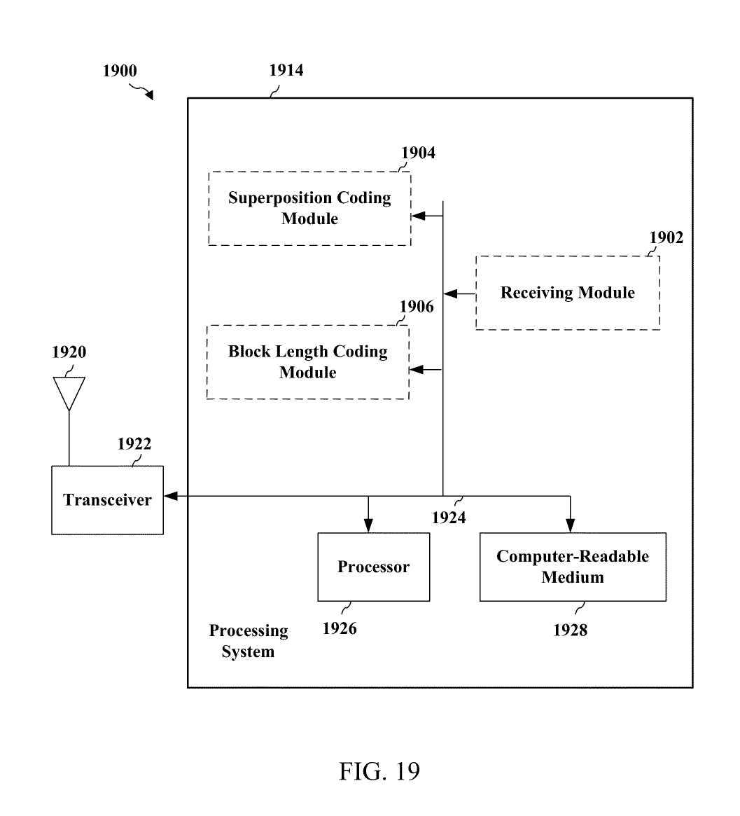

FIG. 19 is a diagram illustrating an example of a hardware implementation for an apparatus 1900 employing a processing system 1914, such as a superposition coding retransmission system and/or a variable block length coding system. The processing system 1914 may be implemented with a bus architecture, represented generally by a bus 1924. The bus 1924 may include any number of interconnecting buses and bridges depending on the specific application of the processing system 1914 and the overall design constraints. The bus 1924 links together various circuits including one or more processors and/or hardware modules, represented by a processor 1926, a receiving module 1902, a superposition coding module 1904, a block length coding module 1906 and a computer-readable medium 1928. The bus 1924 may also link various other circuits such as timing sources, peripherals, voltage regulators, and power management circuits, which are well known in the art, and therefore, will not be described any further.

The apparatus includes the processing system 1914 coupled to a transceiver 1922. The transceiver 1922 is coupled to one or more antennas 1920. The transceiver 1922 provides a means for communicating with various other apparatus over a transmission medium. The processing system 1914 includes the processor 1926 coupled to the computer-readable medium 1928. The processor 1926 is responsible for general processing, including the execution of software stored on the computer-readable medium 1928. The software, when executed by the processor 1926, causes the processing system 1914 to perform the various functions described supra for any particular apparatus. The computer-readable medium 1928 may also be used for storing data that is manipulated by the processor 1926 when executing software. The processing system 1914 further includes the receiving module 1902 for receiving negative acknowledgment of an initially transmitted packet. The processing system 1914 also includes a superposition coding module 1904 for retransmitting one or more packets according to hybrid automatic repeat request using superposition coding in response to the negative acknowledgment. The processing system 1914 also includes a block length coding module 1906 for retransmitting a variable block length packet in response to the negative acknowledgment. The receiving module 1902, superposition coding module 1904 and the block length coding module 1906 may be software modules running in the processor 1926, resident/stored in the computer readable medium 1928, one or more hardware modules coupled to the processor 1926, or some combination thereof. The processing system 1914 may be a component of the eNB and may include the memory 272 and/or the processor 270.

In one configuration, the apparatus 1900 for wireless communication includes retransmitting means. The means may be the superposition coding module 1904, the block length coding module 1906, the superposition coding module 1020, the variable block length coding module 1016, the rate selection module 1022, the rate adjustment module 1018, eNB 1040, eNB 1042, processor 230, memory 232, antenna 224, antenna 1920, transmitter 222, transmit MIMO processor 220, transmit data processor 214, transceiver 1922, processor 1926, computer readable medium 1928, and/or the processing system 1914 configured to perform the functions recited by the means. In another aspect, the aforementioned means may be any module or any apparatus configured to perform the functions recited by the aforementioned means.

In one configuration, the apparatus 1900 for wireless communication includes receiving means. The means may be the superposition coding module 1904, the block length coding module 1906, the superposition coding module 1020, the variable block length coding module 1016, the rate selection module 1022, the rate adjustment module 1018, eNB 1040, eNB 1042, processor 230, memory 232, antenna 224, antenna 1920, receiver 222, receive data processor 214, transceiver 1922, processor 1926, computer readable medium 1928, and/or the processing system 1914 configured to perform the functions recited by the means. In another aspect, the aforementioned means may be any module or any apparatus configured to perform the functions recited by the aforementioned means.

The examples above describe aspects implemented in an LTE system. However, the scope of the disclosure is not so limited. Various aspects may be adapted for use with other communication systems, such as those that employ any of a variety of communication protocols including, but not limited to, CDMA systems, TDMA systems, FDMA systems, and OFDMA systems.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the present disclosure is not intended to be limited to the aspects shown herein but is to be accorded the widest scope consistent with the principles and novel features disclosed herein.

Aspects of the present disclosure are further described in Appendices A, B and C attached. The entirety of Appendices A, B and C are part of this specification and are incorporated by reference.

What is claimed is:

1. A method for wireless communications, the method comprising:
receiving a negative-acknowledgement of an initially transmitted fixed block length packet; and
retransmitting a variable block length packet in response to the negative-acknowledgement.

2. The method of claim 1, in which a block length of the retransmitted packet is a fraction of the fixed block length of the initially transmitted packet.

3. The method of claim 2, further comprising retransmitting the variable block length packet at a rate based at least in part on a variable block length of the retransmitted packet.

4. The method of claim 1, further comprising receiving channel parameters from a user equipment (UE).

5. The method of claim 4, further comprising selecting at least some of the channel parameters for a variable block length coding scheme.

6. An apparatus for wireless communications comprising:
means for receiving a negative-acknowledgement of an initially transmitted fixed block length packet; and
means for retransmitting a variable block length packet in response to the negative-acknowledgement.

7. An apparatus for wireless communications comprising:
a memory; and
at least one processor coupled to the memory and configured:
to receive a negative-acknowledgement of an initially transmitted fixed block length packet; and
to retransmit a variable block length packet in response to the negative-acknowledgement.

8. The apparatus of claim 7, in which a block length of the retransmitted packet is a fraction of the fixed block length of the initially transmitted packet.

9. The apparatus of claim 8, in which the at least one processor is further configured to retransmit the variable block length packet at a rate based at least in part on a variable block length of the retransmitted packet.

10. The apparatus of claim 7, in which the at least one processor is further configured to receive channel parameters from a user equipment (UE).

11. The apparatus of claim 10, in which the at least one processor is further configured to select at least some of the channel parameters for a variable block length coding scheme.

12. A computer program product for wireless communications comprising:
a non-transitory computer-readable medium having program code recorded thereon, the program code comprising:
program code to receive a negative-acknowledgement of an initially transmitted fixed block length packet; and
program code to retransmit a variable block length packet in response to the negative-acknowledgement.

13. A method for wireless communications, the method comprising:
receiving a negative-acknowledgement of an initially transmitted packet; and
retransmitting at least one packet according to hybrid automatic repeat request using superposition coding in response to the negative-acknowledgement.

14. The method of claim 13, further comprising encoding the at least one packet into N codewords.

15. The method of claim 14, further comprising simultaneously retransmitting each of the N codewords.

16. The method of claim 13, further comprising selecting parameters for superposition coding based at least in part on channel parameters received from a user equipment.

17. The method of claim 16, in which the parameters for superposition coding comprises transmit power level and/or transmission rate for each codeword.

18. An apparatus for wireless communications comprising:
means for receiving a negative-acknowledgement of an initially transmitted packet; and
means for retransmitting at least one packet according to hybrid automatic repeat request using superposition coding in response to the negative-acknowledgement.

19. An apparatus for wireless communications comprising:
a memory; and
at least one processor coupled to the memory and configured:
to receive a negative-acknowledgement of an initially transmitted packet; and
to retransmit at least one packet according to hybrid automatic repeat request using superposition coding in response to the negative-acknowledgement.

20. The apparatus of claim 19, in which the at least one processor is further configured to encode the at least one packet into N codewords.

21. The apparatus of claim 20, in which the at least one processor is further configured to simultaneously retransmit each of the N codewords.

22. The apparatus of claim 19, in which the at least one processor is further configured to select parameters for superposition coding based at least in part on channel parameters received from a user equipment.

23. The apparatus of claim 22, in which the parameters for superposition coding comprises transmit power level and/or transmission rate for each codeword.

24. A computer program product for wireless communications comprising:
a non-transitory computer-readable medium having program code recorded thereon, the program code comprising:
program code to receive a negative-acknowledgement of an initially transmitted packet; and
program code to retransmit at least one packet according to hybrid automatic repeat request using superposition coding in response to the negative-acknowledgement.
